(19) United States
(12) Patent Application Publication
(10) Pub. No.: US 2024/0095083 A1
(43) Pub. Date: Mar. 21, 2024

(54) PARALLEL WORKLOAD SCHEDULING BASED ON WORKLOAD DATA COHERENCE

(71) Applicant: Nvidia Corporation, Santa Clara, CA (US)

(72) Inventors: Martin Stich, Memmingen (DE); Rasmus Barringer, Helsingborg (SE); Robert Toth, Lund (SE)

(21) Appl. No.: 18/174,906

(22) Filed: Feb. 27, 2023

Related U.S. Application Data
(60) Provisional application No. 63/408,094, filed on Sep. 19, 2022.

(51) Int. Cl. G06F 9/50

(52) U.S. Cl. CPC G06F 9/505; G06F 9/5033; G06F 9/5072

(57) ABSTRACT

Approaches for addressing issues associated with processing workloads that exhibit high divergence in execution and data access are provided. A plurality of workload items to be processed at least partially in parallel may be identified. Coherence information associated with the plurality of workload items may be determined. The plurality of workload items may be enqueued in a segmented queue. The plurality of workload items may be sorted based at least on a similarity of the coherence information. The sorted plurality of workload items may be stored to the queue. Using a set of processing units, the workload items in the queue may be processed at least partially in parallel according to an order of the sorting.

### CROSS-REFERENCE TO RELATED APPLICATIONS

This application claims priority to U.S. Provisional Application Ser. No. 63/408,094, entitled “Processing Architecture for High Performance Computing” and filed on Sep. 19, 2022, the entirety of which are hereby incorporated herein in its entirety and for all purposes.

### BACKGROUND

Parallel processors, such as graphics processing units (GPUs), may execute workloads efficiently in cases where there is high level of coherence. Coherence may include execution coherence and data coherence. Improving the execution coherence of a workload may result in performance improvements due to better usage of single instruction, multiple data (SIMD) lanes. Improving the data coherence of a workload may result in improved efficiency of various caches, buses, memory management units (MMUs), and dynamic random access memory (DRAM), among other such units. Certain parallel workloads may exhibit high divergence in execution and data access workloads, however, which can make efficient execution of these workloads on a set of processors difficult. As an example, parallel workload processing for ray tracing applications may exhibit high divergence.

### BRIEF DESCRIPTION OF THE DRAWINGS

Various embodiments in accordance with the present disclosure will be described with reference to the drawings, in which:

FIG. 1 illustrates an example reordering process that can be used in accordance with various embodiments.

FIG. 2 illustrates an example system that can be used to implement aspects of the various embodiments.

FIG. 3 illustrates an example queue that can be used to implement aspects of the various embodiments.

FIG. 4 illustrates an example method that can be used in accordance with various embodiments.

FIG. 5 illustrates an example method for reordering workload items that can be used in accordance with various embodiments.

FIG. 6 illustrates an example network configuration that can be used to implement one or more aspects of the various embodiments.

FIG. 7 illustrates an example data center system, according to at least one embodiment.

FIG. 8 illustrates a computer system, according to at least one embodiment.

FIG. 9 illustrates a computer system, according to at least one embodiment.

FIG. 10 illustrates at least portions of a graphics processor, according to one or more embodiments.

FIG. 11 illustrates at least portions of a graphics processor, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (for example, in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, gaming, animation, special effects, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (for example, ray-tracing, path tracing, etc.), collaborative content creation for 3D assets, cloud computing and/or any other suitable applications.

Disclosed embodiments may be comprised in a variety of different systems such as automotive systems (for example, a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

Approaches in accordance with various illustrative embodiments provide for the scheduling and/or re-ordering of work to be performed by one or more processing units. Various workloads, such as parallel workloads, may experience divergence in execution and data access workloads, or both, and that divergence can prevent those workloads from being efficiently executed on one or more processing units, such as execution units of one or more GPUs. In cases of high levels of divergence, such as in ray tracing applications, there may be several instruction streams that could be executed on different processing cores, and memory accesses may be widely spread and randomly distributed, creating inefficiencies in processing. In accordance with one or more embodiments described herein, workload items to be processed by a GPU may be scheduled by reordering workload items on-the-fly, or as needed, in a manner that groups similar workload items together. In an example embodiment, a plurality of workload items to be processed at least partially in parallel may be identified. Coherence information associated with the plurality of workload items may be determined. The plurality of workload items may be enqueued in a segmented queue. The plurality of workload items may be sorted based at least on a similarity of the coherence information. The sorted plurality of workload items may be stored to the queue. Using a set of processing units, the workload items in the queue may be processed at least partially in parallel and according to an order of the sorting.

In this way, execution coherence and data coherence may be extracted simultaneously, or at least concurrently. Further, coherence may be extracted for workload items that are categorized as being similar, as opposed to workload items that are only categorized as being equal. Additionally, scheduling workload items in this way may avoid splitting workload items into “waves,” or a sequence of groupings, where waves must be synchronized globally. Relatively little state information needs to be maintained and may execute without creating additional DRAM traffic. Further, scheduling workload items in accordance with one or more embodiments described herein may allow for deep integration into parallel programming application programming interfaces (APIs) in order to account for application-side knowledge in reordering decisions.

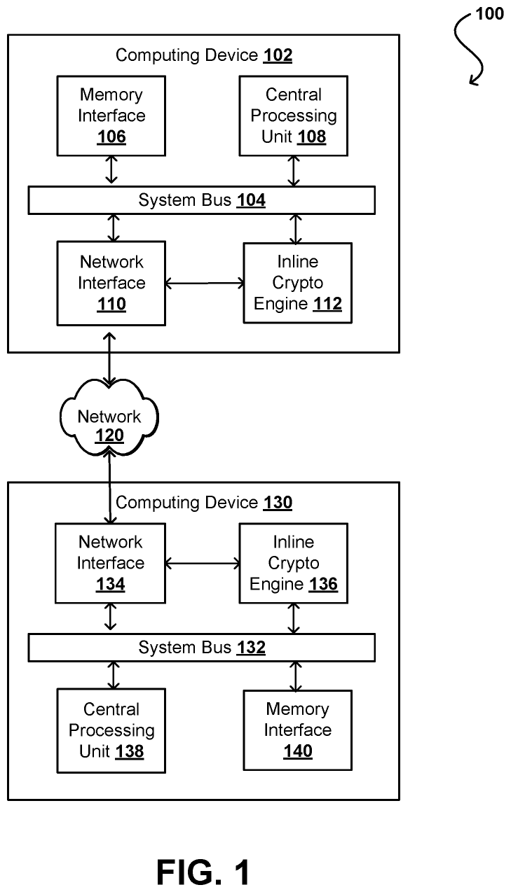

FIG. 1 illustrates an example reordering process 100 that can be used in accordance with various embodiments. Although this example relates to graphics and ray tracing, benefits of scheduling and dynamic re-ordering of tasks may be used beneficially for other types of processing tasks as well, as discussed elsewhere herein. An application or operation may use ray tracing to determine the appropriate light transport through a scene. Rays may be randomly sampled for a scene for use with several different shaders. For example, as shown at 110, a number of graphics processing unit (GPU) threads may shoot a set of primary rays, as depicted by the arrows, into a scene, such as the scene shown at 120. Primary rays, as shown by the horizontal arrows in the scene, hitting the same objects can be assumed to be running the same shader program on each of the threads that hit those objects. Objects in the scene of 120 may include, for example and without limitation, one or more clouds, a brick sidewalk, a number of plants, a bench, and a pillar of a garden scene. In this example, the primary rays are well-ordered so the primary hit shading has high execution efficiency and data locality. For example, as shown at 130, the primary rays, as depicted by the arrows in 130, are in an order of execution such that similar shading work is grouped together. In this way, workload items do not need to be reordered prior to processing.

Secondary rays, as shown by the arrows in 140, may be generated at individual primary ray hit points and shoot off in different directions, hitting different objects. In an example embodiment, a primary ray hit point may be a point where a primary ray hits or touches an object within the scene. As shown in this example, secondary hit shading may be less ordered and less efficient when executing on a GPU because different shader programs may run on the different threads and must often serialize execution. Accessing different materials, textures, or shapes of the scene with very little coherence may create various inefficiencies in how a system is to process the various materials, textures, or shapes. Such inefficiencies may be shown at 150, where different hit points on the left are not grouped based on shading. By reordering workload items to extract the coherence, as shown at 160, the system may be able to more efficiently process the workload items. For example, workload items may reorder pixels based on features of a scene such as materials, textures, or shapes present in the scene.

Additionally, given the randomness of workload items in cases such as in ray tracing, the workload items may be executed across different cores at different times if the workload items are not properly ordered, or reordered, prior to processing. Therefore, by dynamically reordering the workload items to account for similarities between the items and moving the items across at least one GPU core, such as may correspond to a Ray Tracing Texel eXtreme (RTX) or similar processor, for example, the execution of a thread across a GPU core can be performed such that similar processes occur at the same time, at least to an extent possible or practical for a given operation. For example, textures or data buffers may get accessed at the same time from the same sources of the GPU core.

To address at least one or more problems such as those described herein, thread contexts among physical execution units may be dynamically migrated on the GPU such that equal or similar work is processed together. A relatively small subset of the GPU's computing resources may be dedicated to continuously sort through workload items (for example, “logical threads”) based on coherence, while the remaining subset of the GPU's computing resources may be used to process the workload itself.

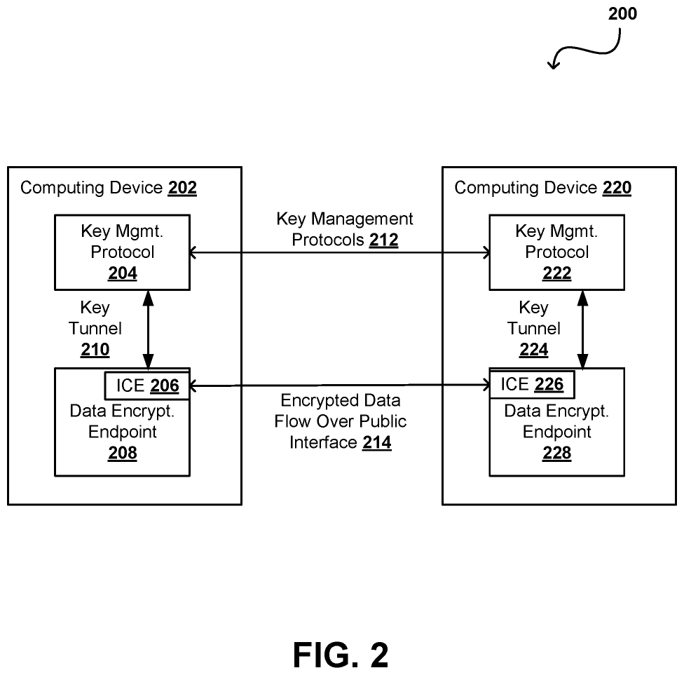

The subset of GPU resources used for sorting may be referred to herein as “sorters,” and GPU resources used for processing the workload may be referred to herein as “workers.” FIG. 2 illustrates an example system 200 that can be used to implement aspects of the various embodiments. In one or more embodiments, a user may be able to submit a request to a computing environment 230 via a client device. The request may be submitted locally, or via at least one network. The computing environment 230 can include at least one processor 240 for processing requests, and a data store 280 for storing ordered workloads, identifiers, and other such information. A processor, according to this example, may be a Graphics Processing Unit (GPU). However, any suitable processing unit may be used. A processor may include a number of streaming multiprocessors (SMs) 250a-250n comprising one or more blocks of threads having associated processing cores. A number of SMs may be dedicated for sorting workload items as “sorters,” and a number of SMs may be dedicated for processing workload items as “workers.” In an example embodiment, the subset of resources for a sorter or worker may be dynamically allocated, or may be determined by a device driver. A queue comprising workload items may be stored to a cache, such as cache 260. Cache 260 may be an L1, L2, or L3 cache, depending in part on the type of processor being used and the type of processing being performed. Processor 240 may further comprise memory 270, which may serve as global memory for the computing environment 230.

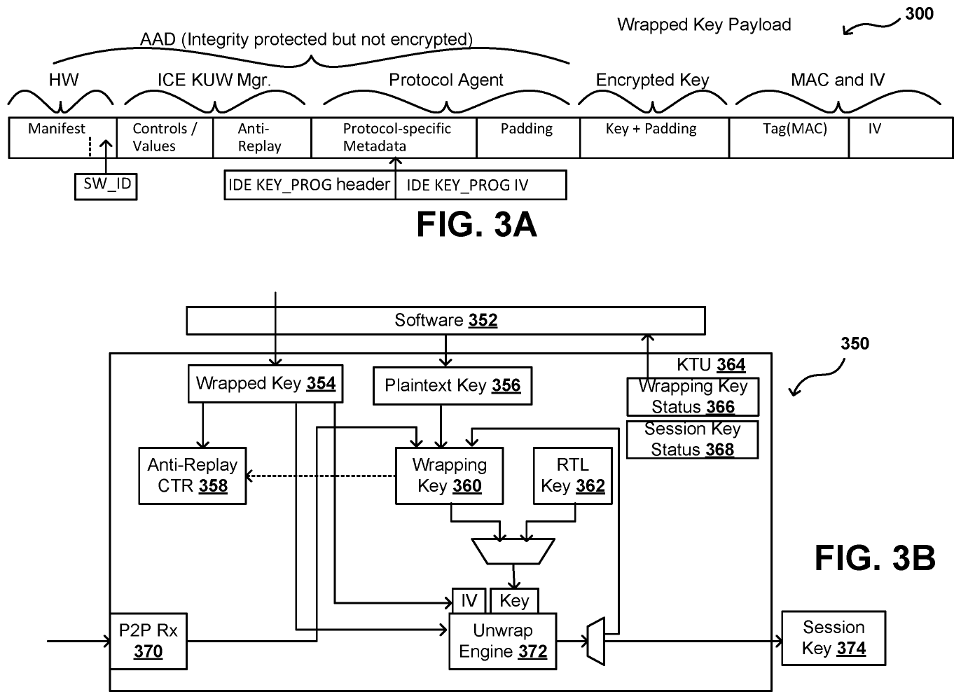

FIG. 3 illustrates data in an example queue 300 that can be used to implement aspects of the various embodiments. An example queue may begin with a number of empty positions 310 available for storing workload items. Workflow items may flow through a global queue 300, where one or more workers may store or enqueue workload items to an enqueuing position 320 of the queue. A global queue may be made up of a number of segments, and there may be numerous threads or slots per segment. Once enough items have been enqueued to a segment 330 (for example, once a determined threshold has been reached, in some embodiments), the workload items may be loaded by a sorter. A portion of the data in a sorting position 340 in the queue will undergo sorting. After being sorted, the data can sit in a sorted position 350 until a worker is available and ready to perform dequeuing. During the dequeuing, the data can be stored in a dequeuing position 360 of the queue. Workers may consume the newly-arranged workload items by dequeuing and processing them, while benefitting from increased coherence. Sorters and workers may run concurrently without requiring global synchronization. Therefore, sorters may not have to wait for all workers to finish, or workers may not have to wait for all sorters to finish, before processing. In this way, tail effects where the GPU is underused may be avoided. Once the global task list contains at least a threshold number of empty positions, a ramp-down phase may be initiated to stop enqueuing altogether. In a ramp-down phase, a current enqueuing segment may be marked as ready for consumption without undergoing sorting. This may simplify the sorting process, because the case of non-full segments does not have to be considered. At the same time, this ramp-down phase ensures that the queue will be drained, and all work items will be processed eventually.

In at least one embodiment, a queue may be partitioned into one or more segments. These segments may be organized in memory, such as by using a ring buffer configuration. While this example describes the use of a segmented ring buffer for the queue, other data structures for managing sets of segments may be used. Additionally, while this embodiment suggests a single global queue, one or more embodiments described herein may be applicable for multiple scheduling domains and multiple queues. A workload processing system may perform a large number of memory operations on the queue. Therefore, the queue may be placed in the fastest available memory, given enough capacity, that can be addressable by the entire scheduling domain. For example, if a scheduling domain comprises the entire GPU, the queue may reside in the last-level cache.

In at least one embodiment, sorting may be performed at a segment level. A sort may be triggered whenever, for example, there is at least a threshold number of unsorted workload items in the queue to fill a segment. Multiple sorts can occur simultaneously depending at least in part on the throughput requirements of the system. Once all sorted items of a segment have been consumed by workers, the segment's memory may be recycled by updating the ring buffer tracking structures such that the segment may be marked as available for enqueuing.

Information stored on a queue may be separated into categories, including (1) data that is needed by sorters, and (2) data that is only preserved while sorting takes place but is never actually used by the sorters. Because the data that is needed by sorters is accessed more frequently, this data may be kept as small as possible. In accordance with an example embodiment, a key-value-pair (KVP) may be used. A KVP may consist of a key for the sorter to determine a desired ordering, and a value that the sorter may ignore. The value may represent information required to resume execution, for example an index or a pointer to additional data.

Enqueuing to, and dequeuing from, the queue may occur in a lock-free manner using atomics such that a processor may work concurrently with other processors without interfering with each other. Atomics may be used to keep track of what stage a current segment is in. Dequeuing may occur in batches, such that a consuming worker may benefit from the increased coherence of the sorted work items. For example, on a GPU where the SIMD width is of a determined number, a worker may consume that number of workload items at a time. If a queue becomes full, workers may not be able to enqueue additional work items until space is made available by other workers that are dequeuing work items from the queue. To avoid stalling, in an example embodiment, enqueuing workers may choose to continue processing their workload items without sorting them, instead of waiting for queue space to become available. Additionally, workers in a SIMD group may elect to continue processing their workload items even if there is space available in the queue if the workload items are determined to be already highly coherent. Ensuring memory consistency between enqueuing and dequeuing may be amortized across one or more segments depending on timing, such as whether there is an overlap in time. Amortizing across multiple segments may assume that the KVPs are separately synchronized at a higher frequency to be visible to the sorter.

KVPs may be sorted to organize the workload items that the KVPs represent. Conventional methods may involve assigning equal keys to buckets. In contrast, one or more embodiments described herein may advantageously sort the KVPs by robustly handling arbitrary key distributions at any key resolution without having to make tradeoffs related to bucket granularity and memory management. Further, sorting may automatically group similar keys together, which can extract more coherence than only grouping equal keys.

Sorting work through a segmented queue may be non-deterministic on a parallel processor. For example, unless special precautions are taken, the order in which workload items are enqueue may be non-deterministic. This type of sorting may result in non-deterministic segment content and therefore non-deterministic sort results. Because reordering may be implemented for performance reasons and not for correctness, this is non-problematic. To the contrary, because it may be more desirable to optimize for performance, a fast and approximate sorting algorithm may be employed instead of a slower but precise algorithm. Depending on the sort algorithm, performance may be improved by only considering some fraction of the keys' most significant bits instead of considering the full keys. With a small enough number of relevant key bits to consider, bucketing may be used instead of full sorting.

Additionally, the quality of keys used in the KVPs may affect one or more performance benefits associated with workload reordering. High-quality keys may represent future execution paths and/or future memory accesses as accurately as possible, such that when workload items with equal or similar keys are executed together (for example, within the same SIMD wave or on the same local processor), the underlying hardware may take advantage of the similarity.

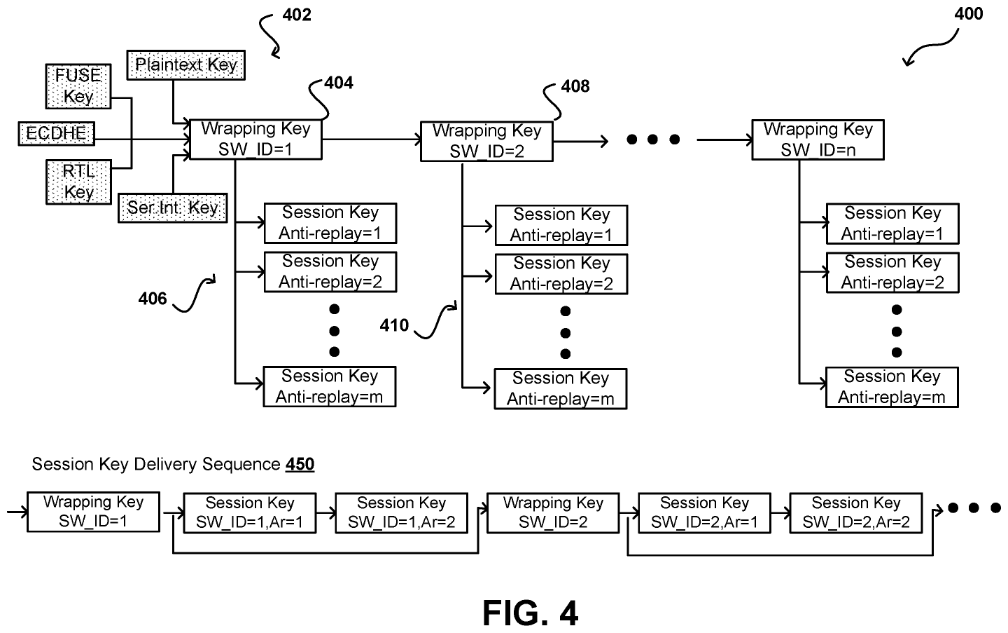

FIG. 4 illustrates an example method 400 that can be performed in accordance with various embodiments. For this and other processes discussed herein that there may be additional, fewer, or alternative steps performed in similar or alternative orders, or at least partially in parallel, within the scope of the various embodiments unless otherwise specifically stated. In this example, a key, or a coherence key, may be chosen or determined 410, such as whenever a thread decides to enqueue its workload item for reordering. Depending at least in part on an underlying programming model and situation, for example, a key may be provided directly by an application, computed by system software, or may be a composition of both. A challenge with key selection is that sorters may only support a limited number of key bits, thereby limiting the granularity at which a coherence metric can be expressed. However, available bits may be used without restriction. For example, available bits may be used to encode a hierarchy of coherence metrics (for example, “first sort by dimension A, and then by dimension B”). In ray tracing applications, coherence keys for ray hits may be computed to improve the performance of subsequent shading operations. For example, keys may be computed based at least on information about the shading codepaths that will be executed, as well as object and primitive identifiers to help extract data coherence.

Once the key values have been computed, an order in which the workload items are to be sorted may be determined based at least on the key values 420. For example, the key values may be used as an indication of how to group similar workload items together as part of the sorting process. By sorting in this way, more coherence may be extracted than from only grouping equal keys. After the ordering has been determined, the workload items may be sorted according to the determined ordering 430.

As an illustrative example, in ray tracing applications, coherence keys for ray hits may be computed to improve the performance of subsequent shading operations. For example, keys may be computed based at least on information about the shading codepaths that will be executed, as well as object and primitive identifiers to help extract data coherence.

In an example embodiment, keys may be approximated by having sorters perform a second, data dependent, compression of keys to reduce sorting costs. Before the sorting process for a segment begins, statistics about the keys present in the segment may be used to dynamically allocate compressed key bits to the various pieces of information. Statistics may either be gathered by the sorter itself before sorting, or be progressively updated by workers as they enqueue workload items to a segment. The compression of keys may reduce a total number of bits allocated to threads in a segment, thereby improving the efficiency of the sort. In an example embodiment, a key may include various components, including a Shader Identifier (ID) in ray tracing applications. The Shader ID, in accordance with an example embodiment, may identify which material shader or which piece of code to execute next. Each thread may have some idea of which shader code to execute next depending on one or more properties of the object such as texture, material, or shape. The Shader ID may be represented by a numerical value. For example, there may be multiple objects within a scene that all have a certain material attached to it, like brick floors or wooden benches. However, they may all have different textures that control the object's actual appearance or part of their appearance. Therefore, in accordance with this example embodiment, Shader IDs may be grouped together and processed, but there may also be textures that are associated with the Shader IDs that can be accounted for before sorting. This additional information may provide additional coherence based on which texture needs to be accessed. A compressed key may correspond to a single key associated with a single value. One compressed key may correspond to a shader value, and other compressed keys may account for other attributes of the objects, including material type or texture. When sorting, a sorter may sort first by the first key and then by another key, such as sorting first by the Shader ID and then by the material type, texture type, or shape corresponding to the compressed keys. Sorting by a single value instead of a number of values to a single key may enable the sorting process to occur more efficiently, without being too computationally expensive.

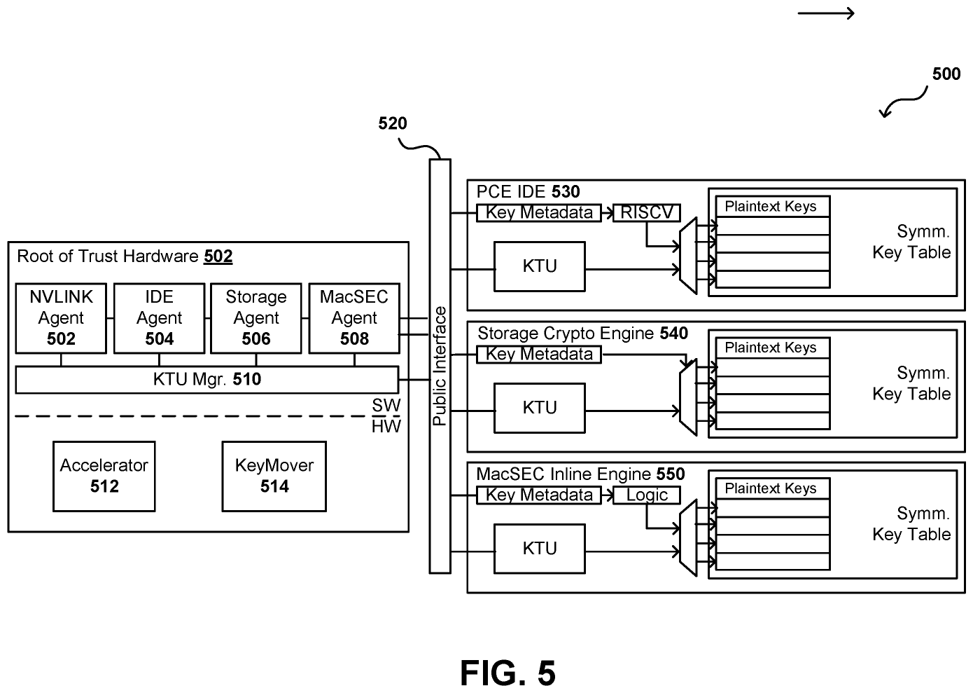

FIG. 5 illustrates an example method 500 for reordering workload items that can be used in accordance with various embodiments. In accordance with an example embodiment, a plurality of workload items to be processed at least partially in parallel may be identified 510. In at least one example, workload items may correspond to items in ray tracing workloads, or items in workloads for that exhibit divergence in coherence. For example, in ray tracing applications, shader divergence can significantly reduce a GPU's efficiency because GPUs are extremely parallel processors and may be the most effective when running similar workloads simultaneously. Divergence, at least in this example, may occur when rays hit objects within a scene, generating secondary rays that bounce off more objects, where the objects all have different material properties (for example, textures, colors, reflections, shapes, and other artifacts, among other such options) that must also be accounted for. Further, divergence may worsen as more complex lighting techniques, such as path tracing, are employed. Divergence may take two forms in this example: (1) execution divergence, where different threads execute different shaders or branches within a shader; and (2) data divergence, where different threads access memory resources that are hard to coalesce or cache.

Coherence information associated with the plurality of workload items may be determined 520.

The plurality of workload items may be enqueued in a segmented queue 530. If a segment is available for enqueuing, such as when all sorted items of a segment have been consumed by workers, new workload items, such as workload items of 510, may be enqueued to the segment. In an example embodiment, a key may be chosen whenever a GPU thread decides to enqueue its work item for reordering. In this way, enqueued items may be associated with coherence keys prior to sorting.

Once the key values have been assigned to the coherence keys, an order in which the workload items are to be sorted may be determined based at least on the key values. For example, the key values may be used as an indication of how to group similar workload items together as part of the sorting process. By sorting in this way, more coherence may be extracted than from only grouping equal keys. After the ordering has been determined, the workload items may be sorted according to the determined ordering. In accordance with an example embodiment, the plurality of workload items may be sorted based at least on a similarity of the coherence information 540.

The sorted workload items may be stored back to the queue 550, where the stored items may be processed, using a set of processing units, at least partially in parallel according to an order of the sorting 560. In this example, the set of processing units may correspond to the set of GPU resources allocated to the “workers.” Workload items may be organized and reordered on the fly so that they can be processed by a processing core more efficiently. By reordering in this way, some workloads may be processed two to three times faster than without reordering. Additionally, by reordering workload items, rays of a ray tracing application may be traced faster, without compromising visual quality. Reordering and grouping secondary hit shading to have better execution locality may generate a much higher overall path traced shading efficiency. While this example describes the use of reordering with respect to ray tracing applications, reordering may not be required for every workload item within a ray tracing application. For example, reordering may not be required in instances where rays are highly coherent, such as where primary rays come directly through an imaging device, hitting mostly the same things. Such an imaging device, according to this example, may include a pinhole camera. However, in cases where ray tracing may be more computationally expensive, reordering may improve one or more operations of a computing device because such use cases may be more computationally intensive. Such instances may occur during a reflections pass of a ray tracing application, in execution of multi-bounce stochastic path tracing algorithms in complex scenes, or when path tracing complex materials, among other such instances.

As explained, some parallel workloads experience divergence in either execution coherence, data coherence, or both, making efficient execution of these workloads on GPUs difficult. Secondary hit shading may be less ordered and less efficient when executing on a GPU because different shader programs may run on the different threads and must often serialize execution. Accessing different materials, textures, or shapes of the scene with very little coherence may create various inefficiencies in how a system is to process the various materials, textures, or shapes. By reordering workload items to extract the coherence, the system may be able to more efficiently process the workload items. Coherence information, in this example embodiment, may be provided in the form of a key of a key-value pair. A key, or a coherence key, may be chosen or determined whenever a thread decides to enqueue its workload item for reordering. Depending on an underlying programming model and situation, a key may be provided directly by the application, computed by system software, or may be a composition of both. A challenge with key selection is that sorters may only support a limited number of key bits, thereby limiting the granularity at which a coherence metric can be expressed. However, available bits may be used without restriction. For example, available bits may be used to encode a hierarchy of coherence metrics (e.g., “first sort by dimension A, and then by dimension B”). In ray tracing applications, coherence keys for ray hits may be computed to improve the performance of subsequent shading operations. For example, keys may be computed based at least on information about the shading codepaths that will be executed, as well as object and primitive identifiers to help extract data coherence. Based at least on this information, key values may be assigned to the coherence keys.

In ray tracing applications, for example, coherence keys for ray hits may be computed to improve the performance of subsequent shading operations. For example, keys may be computed based at least on information about the shading codepaths that will be executed, as well as object and primitive identifiers to help extract data coherence.

In an example embodiment, keys may be approximated by having sorters perform a second, data dependent, compression of keys to reduce sorting costs. Before the sorting process for a segment begins, statistics about the keys present in the segment may be used to dynamically allocate compressed key bits to the various pieces of information. Statistics may either be gathered by the sorter itself before sorting, or be progressively updated by workers as they enqueue workload items to a segment. To optimize the use of available computing resources, system parameters may be selected or defined such that the involved components are well balanced. For example, some parameters may be chosen statically, based on the constraints of the implementation and the hardware. Other parameters may be chosen based on the situation, and may require dynamic adjustment based on measured metrics. In some examples, the adjustment may occur manually or automatically.

An example parameter, in accordance with some embodiments, is segment size. Segment size may affect performance in various ways. For example, larger segments may take longer to sort, which increases queue latency (e.g., the average amount of time that a workload item spends in the queue including the sort). Increased queue latency may lead to increased pressure on queue capacity, which in turn decreases the overall availability of system resources (for example, the amount of last-level cache available to workers). Slower sorting may also require more sorters having to run simultaneously, thereby taking away more computing resources from workers in order to keep up the throughput. Larger segments, however, may be better at extracting coherence because they form a larger search space for similar work. In accordance with an example embodiment, segment size may be fixed for a given GPU architecture.

Another system parameter, in accordance with an example embodiment, may include the allowed amount of approximation in the sort. There may be a tradeoff between faster, less precise sorts and slower, but more precise sorts. Increased approximation and therefore faster sorts may come at the cost of coherence because a worse-quality sort may fail to group similar or equal workload items close enough together. In some embodiments, the allowed amount of approximation in the sort may be fixed for a given GPU architecture.

A sorter count may be another system parameter that can help optimize the use of available computing resources. Sorter count may be defined as the fraction of computing resources dedicated to sorting. Choosing the right sorter count may be critical to avoid both starving the sorters and oversubscribing the sorters. In ray tracing, performance behavior of workloads may be highly unpredictable. This may hold true for both workloads of different categories, as different ray tracing effects tend to stress the system in different ways, and also within a workload itself. Therefore, the number of sorters may be dynamically adjusted at particular intervals. The sorter count, in some example embodiments, may be determined by an amount of load experienced by the sorters during a previous interval.

A workload may consist of more workload items than can fit on a GPU. For example, in ray tracing applications, millions of pixels may be processed at a given time, with each pixel representing one workload items, while the GPU has resources for approximately tens of thousands of threads. The total workload may be represented as a global list of tasks from which workers can pull new workload items whenever a system is underused. For example, during startup, a reorder queue may initially be empty and therefore underused. During steady-state operation, an amount of queue segments ready to be consumed may be monitored. The way workers prioritize between consuming from the queue and adding new work to the system from a work list may be adjusted to keep the amount of work that is ready for consumption relatively small without reducing the workload so much that sudden bursts of available workers cannot be satisfied without adding large amounts of new work to the system. By keeping the available work for consumption small, the queue footprint in memory can be minimized.

Once the global task list becomes empty, a ramp-down phase may be initiated to stop enqueuing altogether. In a ramp-down phase, a current enqueuing segment may be marked as ready for consumption without undergoing sorting. This simplifies the sorting process, because the case of non-full segments does not have to be considered. At the same time, this ramp-down phase ensures that the queue will be drained, and all work items will be processed eventually.

System software exposed through an application programming interface (API) may be used to implement one or more embodiments described herein. Directly implementing workload reordering as described herein through an application may have several downsides. For example, a robust and performant implementation may incur a level of complexity and platform-specific tuning that application developers may not be able to address. Additionally, invoking reordering in client code without explicit support from the compiler may require cumbersome, user-unfriendly constructs especially in more sophisticated applications. Further, application software may be limited to accessing hardware functionality exposed by public programming models, while a system runtime may operate at a lower level to achieve higher performance.

An API may consist of a single reordering function that can trigger enqueuing of a calling thread's current work item. A reordering function may either compute a key automatically from a current state (such as a ray hit, for example), or the key may be passed as an argument by the application. In this way, workloads may be scheduled using application-specific knowledge, while shielding the application from the complexities associated with the underlying reordering implementation.

Additionally, the amount of thread-local state data that must be saved and restored on the queue may affect reordering performance. One or more compiler optimizations may be employed to reduce the state data as much as possible, and chip-specific load patterns or store patterns may be generated for any remaining state data. Further, one or more platform tools may enable developers to optimize their applications for reordering.

Aspects of various approaches presented herein can be lightweight enough to execute on a device such as a client device, including a personal computer or gaming console, in real time. Such processing can be performed on content (for example, a rendered version of a unique asset) that is generated on, or received by, that client device or received from an external source, such as streaming data or other content received over at least one network. In some instances, the processing and/or determination of this content may be performed by one of these other devices, systems, or entities, then provided to the client device (or another such recipient) for presentation or another such use.

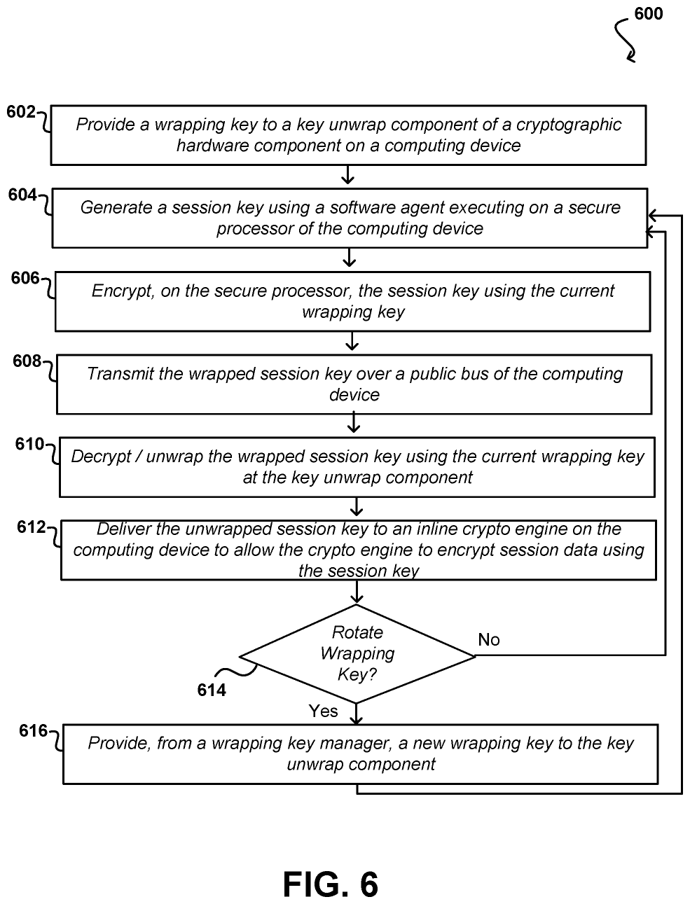

As an example, FIG. 6 illustrates an example network configuration 600 that can be used to implement one or more aspects of the various embodiments. In at least one embodiment, a client device 602 can generate or receive data for a session using components of a content application 604 executing on client device 602 and data stored locally on that client device. In at least one embodiment, a content application 624 executing on a server 620 (for example, a cloud server or edge server) may initiate a session associated with at least client device 602, as may use a session manager and user data stored in a user database 634, and can cause content 632 to be determined by a content manager 626. A content manager 626 may work with a workload processor 628 to reorder workload items of a ray tracing application other such application to be provided for presentation via the client device 602. At least a portion of the processed content may be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding content application 604, which may also or alternatively include a graphical user interface 610, content manager 612, and workload item reordering module 614 for use in reordering workload items associated with content to be for presentation via the client device 602. A decoder may also be used to decode data received over the network(s) 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 634, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for reordering workload items in a queue for raytracing applications. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

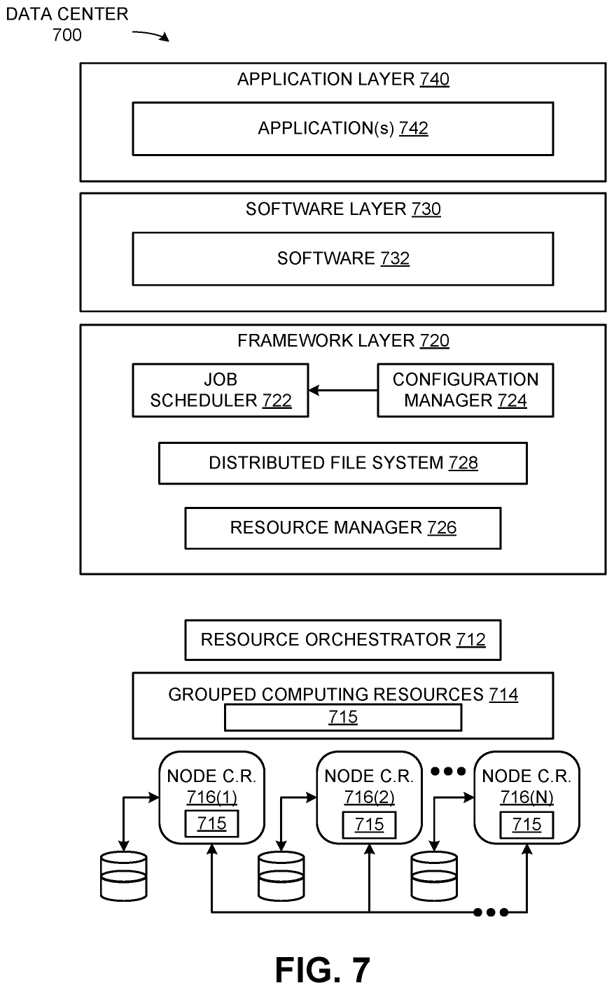

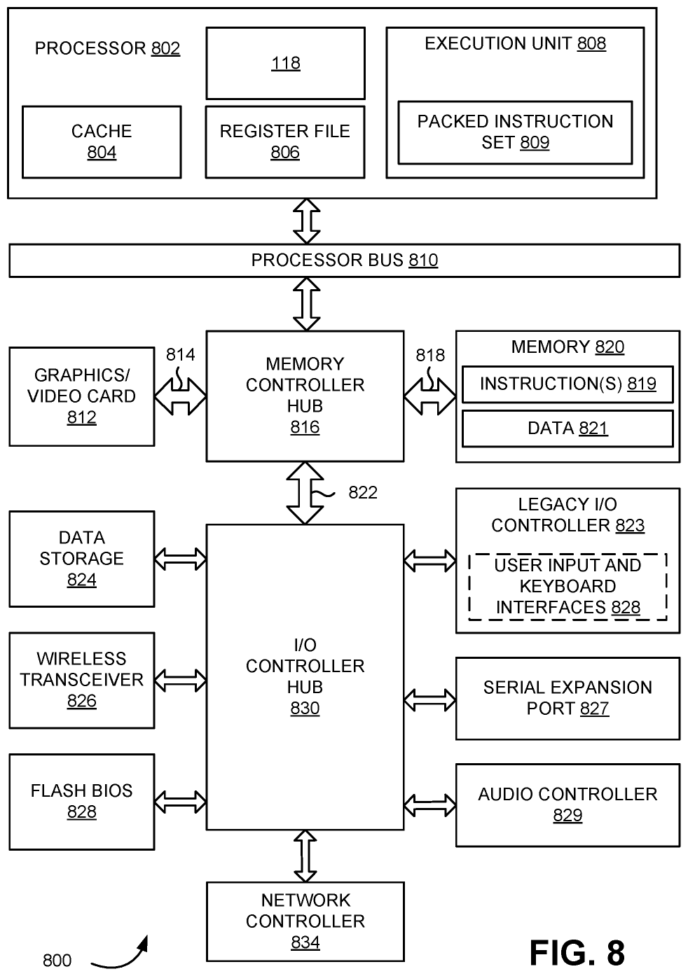

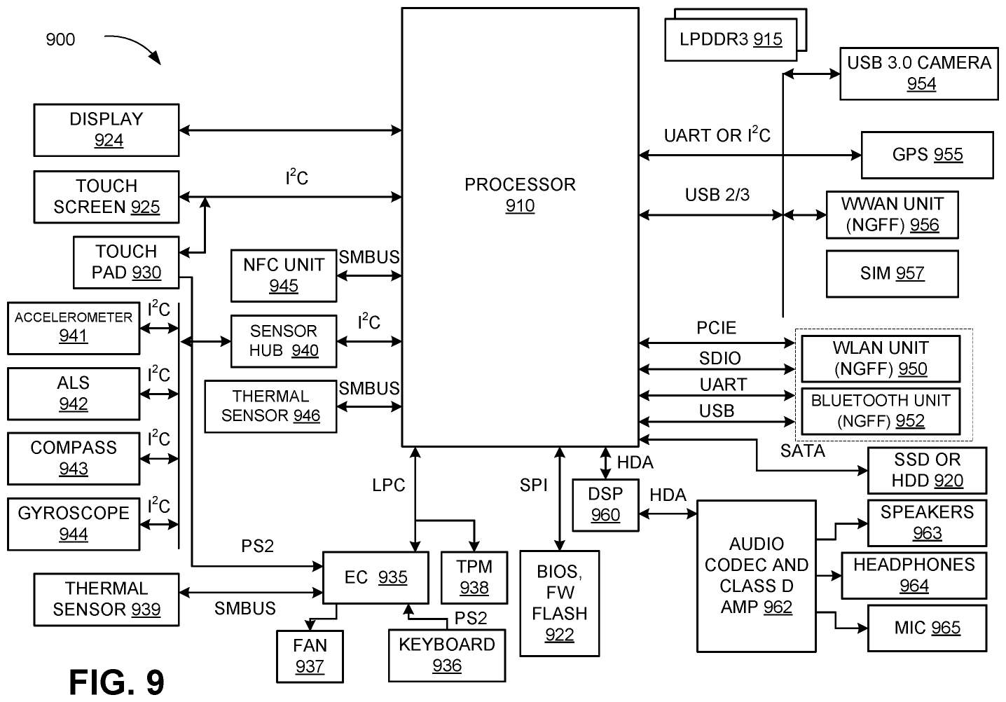

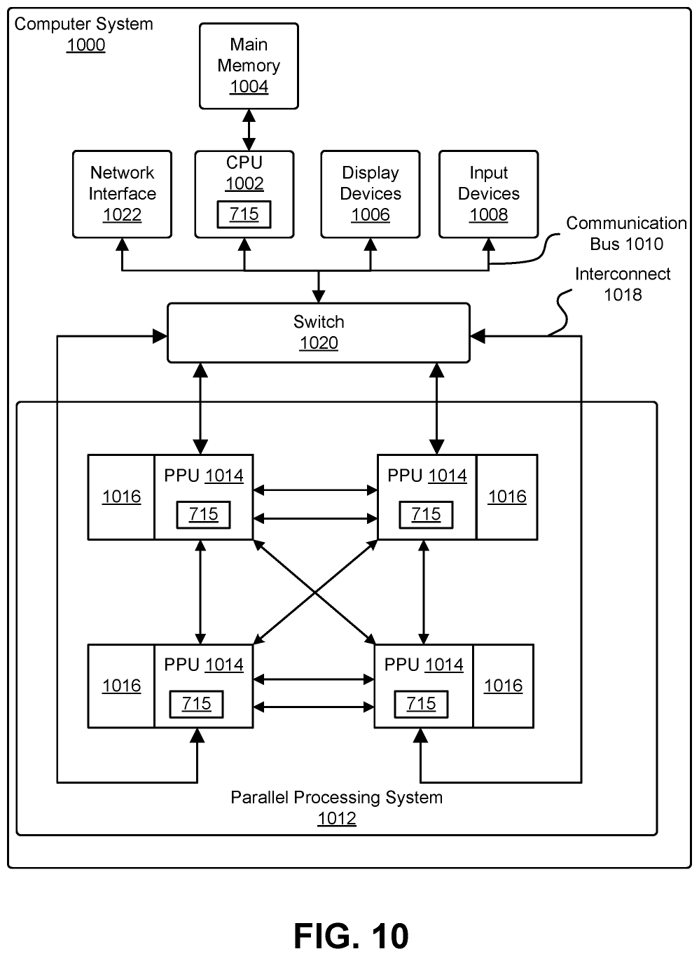

One or more of the various embodiments described herein can be performed on a standalone client device, or a remote server in a data center, among other such options. FIG. 7, discussed in more detail below, illustrates example components of a data center, while FIG. 8 illustrates components of a computer, such as a desktop computer or content server. Generation of image data in at least one embodiment can be performed in a graphics processing unit (GPU) that supports ray tracing, as discussed with respect to FIGS. 9 and 10, but can also be executed using CPUs, combination GPU/CPUs, or other such processing devices.

### Data Center

FIG. 7 illustrates an example data center 700, in which at least one embodiment may be used. In at least one embodiment, data center 700 includes a data center infrastructure layer 710, a framework layer 720, a software layer 730, and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may use distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 714 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underused and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Such components can be used to reorder and process workload items in an efficient manner.

### Computer Systems

FIG. 8 is a block diagram illustrating an exemplary computer system, which may be a system with interconnected devices and components, a system-on-a-chip (SOC) or some combination thereof 800 formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment computer system 800 may be a multiprocessor system. In at least one embodiment, processor 02 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interfaces 825, a serial expansion port 827, such as Universal Serial Bus (“USB”), and a network controller 832. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 800 are interconnected using compute express link (CXL) interconnects.

Such components can be used to reorder and process workload items in an efficient manner.

FIG. 9 is a block diagram illustrating an electronic device 900 for using a processor 910, according to at least one embodiment. In at least one embodiment, electronic device 900 may be, for example and without limitation, a notebook, a tower server, a rack server, a blade server, a laptop, a desktop, a tablet, a mobile device, a phone, an embedded computer, or any other suitable electronic device.

In at least one embodiment, system 900 may include, without limitation, processor 910 communicatively coupled to any suitable number or kind of components, peripherals, modules, or devices. In at least one embodiment, processor 910 coupled using a bus or interface, such as a I²C bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices illustrated in FIG. 9 may be interconnected with proprietary interconnects, standardized interconnects (e.g., PCIe) or some combination thereof. In at least one embodiment, one or more components of FIG. 9 are interconnected using compute express link (CXL) interconnects.

In at least one embodiment, FIG. 9 may include a display 924, a touch screen 925, a touch pad 930, a Near Field Communications unit (“NFC”) 945, a sensor hub 940, a thermal sensor 946, an Express Chipset (“EC”) 935, a Trusted Platform Module (“TPM”) 938, BIOS/firmware/flash memory (“BIOS, FW Flash”) 922, a DSP 960, a drive 920 such as a Solid State Disk (“SSD”) or a Hard Disk Drive (“HDD”), a wireless local area network unit (“WLAN”) 950, a Bluetooth unit 952, a Wireless Wide Area Network unit (“WWAN”) 956, a Global Positioning System (GPS) 955, a camera (“USB 3.0 camera”) 954 such as a USB 3.0 camera, and/or a Low Power Double Data Rate (“LPDDR”) memory unit (“LPDDR3”) 915 implemented in, for example, LPDDR3 standard. These components may each be implemented in any suitable manner.

In at least one embodiment, other components may be communicatively coupled to processor 910 through components discussed above. In at least one embodiment, an accelerometer 941, Ambient Light Sensor (“ALS”) 942, compass 943, and a gyroscope 944 may be communicatively coupled to sensor hub 940. In at least one embodiment, thermal sensor 939, a fan 937, a keyboard 936, and a touch pad 930 may be communicatively coupled to EC 935. In at least one embodiment, at least one speaker 963, headphones 964, and microphone (“mic”) 965 may be communicatively coupled to an audio unit (“audio codec and class d amp”) 962, which may in turn be communicatively coupled to DSP 960. In at least one embodiment, audio unit 962 may include, for example and without limitation, an audio coder/decoder (“codec”) and a class D amplifier. In at least one embodiment, SIM card (“SIM”) 957 may be communicatively coupled to WWAN unit 956. In at least one embodiment, components such as WLAN unit 950 and Bluetooth unit 952, as well as WWAN unit 956 may be implemented in a Next Generation Form Factor (“NGFF”).

Such components can be used to reorder and process workload items in an efficient manner.

FIG. 10 is a block diagram of a processing system, according to at least one embodiment. In at least one embodiment, system 1000 includes one or more processors 1002 and one or more graphics processors 1008, and may be a single processor desktop system, a multiprocessor workstation system, or a server system having a large number of processors 1002 or processor cores 1007. In at least one embodiment, system 1000 is a processing platform incorporated within a system-on-a-chip (SoC) integrated circuit for use in mobile, handheld, or embedded devices.

In at least one embodiment, system 1000 can include, or be incorporated within a server-based gaming platform, a game console, including a game and media console, a mobile gaming console, a handheld game console, or an online game console. In at least one embodiment, system 1000 is a mobile phone, smart phone, tablet computing device or mobile Internet device. In at least one embodiment, processing system 1000 can also include, couple with, or be integrated within a wearable device, such as a smart watch wearable device, smart eyewear device, augmented reality device, or virtual reality device. In at least one embodiment, processing system 1000 is a television or set top box device having one or more processors 1002 and a graphical interface generated by one or more graphics processors 1008.

In at least one embodiment, one or more processors 1002 each include one or more processor cores 1007 to process instructions which, when executed, perform operations for system and user software. In at least one embodiment, each of one or more processor cores 1007 is configured to process a specific instruction set 1009. In at least one embodiment, instruction set 1009 may facilitate Complex Instruction Set Computing (CISC), Reduced Instruction Set Computing (RISC), or computing via a Very Long Instruction Word (VLIW). In at least one embodiment, processor cores 1007 may each process a different instruction set 1009, which may include instructions to facilitate emulation of other instruction sets. In at least one embodiment, processor core 1007 may also include other processing devices, such a Digital Signal Processor (DSP).

In at least one embodiment, processor 1002 includes cache memory 1004. In at least one embodiment, processor 1002 can have a single internal cache or multiple levels of internal cache. In at least one embodiment, cache memory is shared among various components of processor 1002. In at least one embodiment, processor 1002 also uses an external cache (e.g., a Level-3 (L3) cache or Last Level Cache (LLC)) (not shown), which may be shared among processor cores 1007 using known cache coherency techniques. In at least one embodiment, register file 1006 is additionally included in processor 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor 1002 and other components in system 1000. In at least one embodiment, interface bus 1010, in one embodiment, can be a processor bus, such as a version of a Direct Media Interface (DMI) bus. In at least one embodiment, interface bus 1010 is not limited to a DMI bus, and may include one or more Peripheral Component Interconnect buses (e.g., PCI, PCI Express), memory busses, or other types of interface busses. In at least one embodiment processor(s) 1002 include an integrated memory controller 1016 and a platform controller hub 1030. In at least one embodiment, memory controller 1016 facilitates communication between a memory device and other components of system 1000, while platform controller hub (PCH) 1030 provides connections to I/O devices via a local I/O bus.

In at least one embodiment, memory device 1020 can be a dynamic random access memory (DRAM) device, a static random access memory (SRAM) device, flash memory device, phase-change memory device, or some other memory device having suitable performance to serve as process memory. In at least one embodiment memory device 1020 can operate as system memory for system 1000, to store data 1022 and instructions 1021 for use when one or more processors 1002 executes an application or process. In at least one embodiment, memory controller 1016 also couples with an optional external graphics processor 1012, which may communicate with one or more graphics processors 1008 in processors 1002 to perform graphics and media operations. In at least one embodiment, a display device 1011 can connect to processor(s) 1002. In at least one embodiment display device 1011 can include one or more of an internal display device, as in a mobile electronic device or a laptop device or an external display device attached via a display interface (e.g., DisplayPort, etc.). In at least one embodiment, display device 1011 can include a head mounted display (HMD) such as a stereoscopic display device for use in virtual reality (VR) applications or augmented reality (AR) applications.

In at least one embodiment, platform controller hub 1030 enables peripherals to connect to memory device 1020 and processor 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 can connect via a storage interface (e.g., SATA) or via a peripheral bus, such as a Peripheral Component Interconnect bus (e.g., PCI, PCI Express). In at least one embodiment, touch sensors 1025 can include touch screen sensors, pressure sensors, or fingerprint sensors. In at least one embodiment, wireless transceiver 1026 can be a Wi-Fi transceiver, a Bluetooth transceiver, or a mobile network transceiver such as a 3G, 4G, or Long Term Evolution (LTE) transceiver. In at least one embodiment, firmware interface 1028 enables communication with system firmware, and can be, for example, a unified extensible firmware interface (UEFI). In at least one embodiment, network controller 1034 can enable a network connection to a wired network. In at least one embodiment, a high-performance network controller (not shown) couples with interface bus 1010. In at least one embodiment, audio controller 1046 is a multi-channel high definition audio controller. In at least one embodiment, system 1000 includes an optional legacy I/O controller 1040 for coupling legacy (e.g., Personal System 2 (PS/2)) devices to system. In at least one embodiment, platform controller hub 1030 can also connect to one or more Universal Serial Bus (USB) controllers 1042 connect input devices, such as keyboard and mouse 1043 combinations, a camera 1044, or other USB input devices.

In at least one embodiment, an instance of memory controller 1016 and platform controller hub 1030 may be integrated into a discreet external graphics processor, such as external graphics processor 1012. In at least one embodiment, platform controller hub 1030 and/or memory controller 1016 may be external to one or more processor(s) 1002. For example, in at least one embodiment, system 1000 can include an external memory controller 1016 and platform controller hub 1030, which may be configured as a memory controller hub and peripheral controller hub within a system chipset that is in communication with processor(s) 1002.

Such components can be used to reorder and process workload items in an efficient manner.

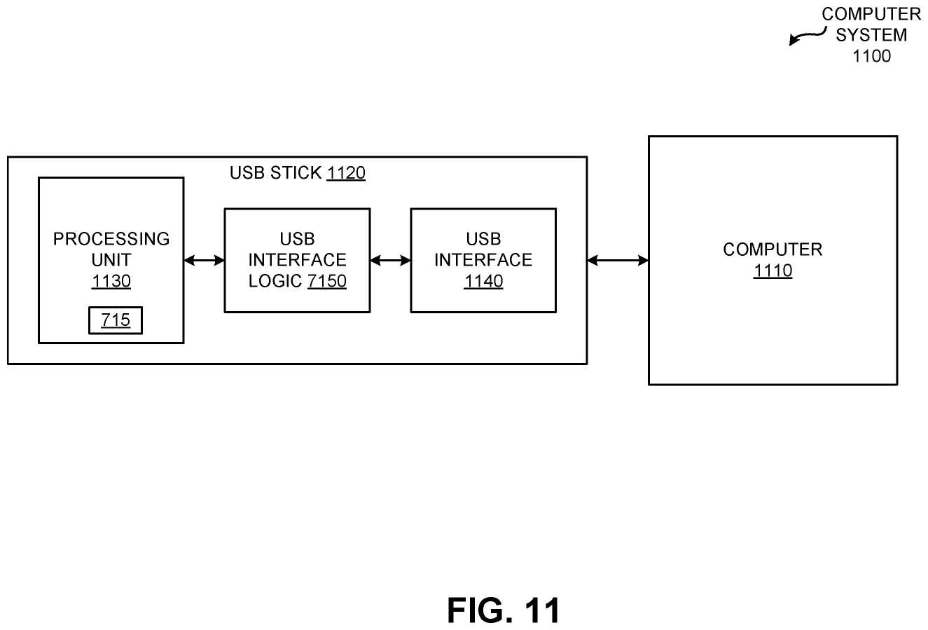

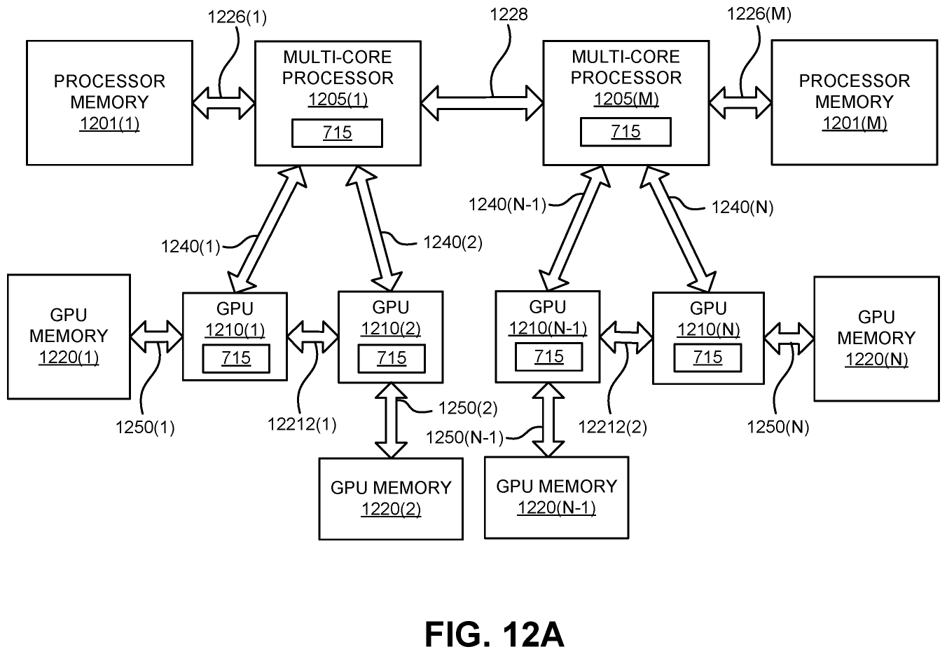

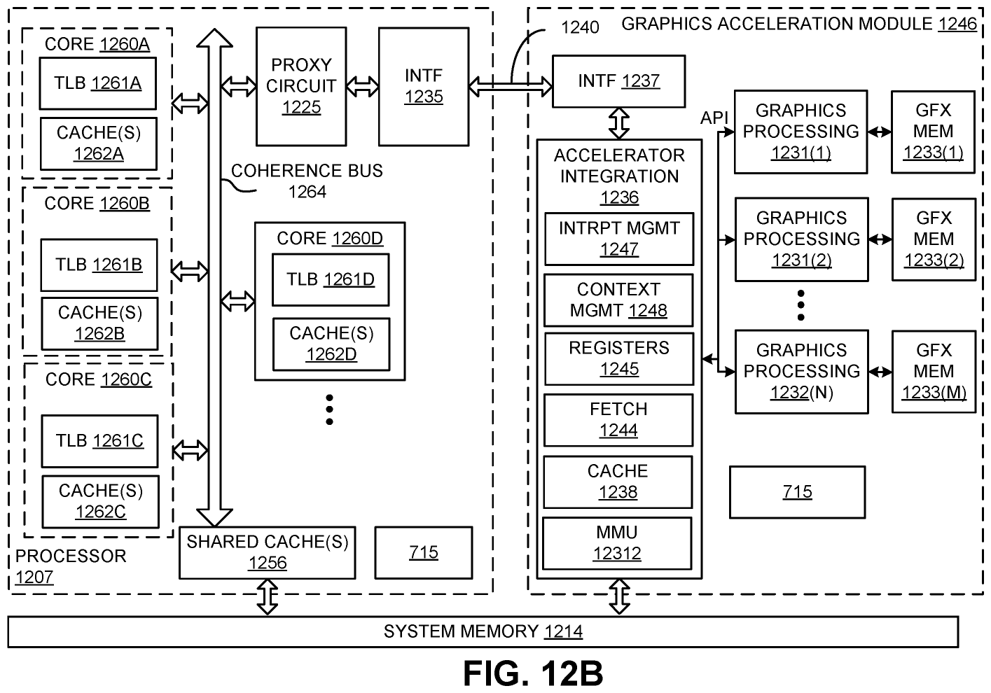

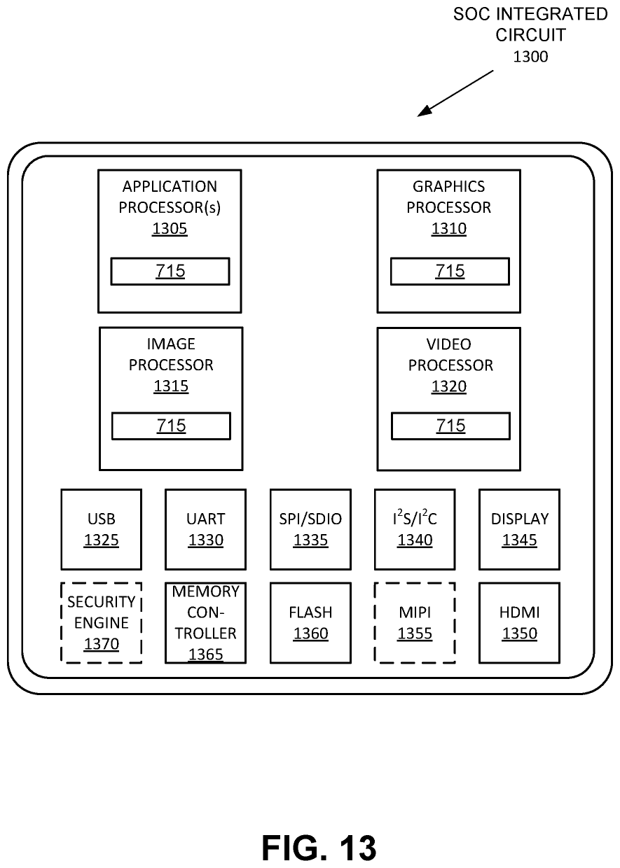

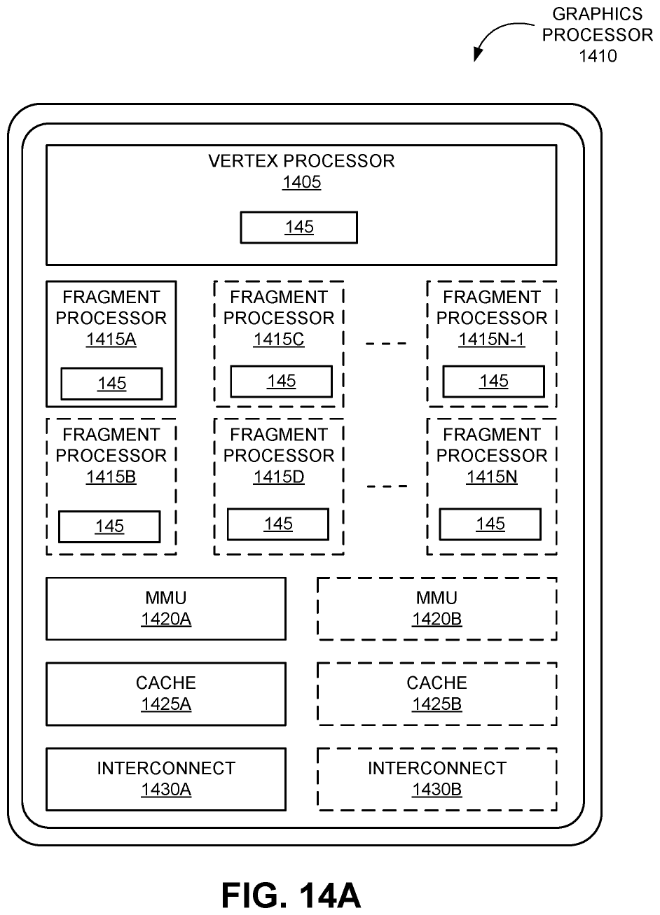

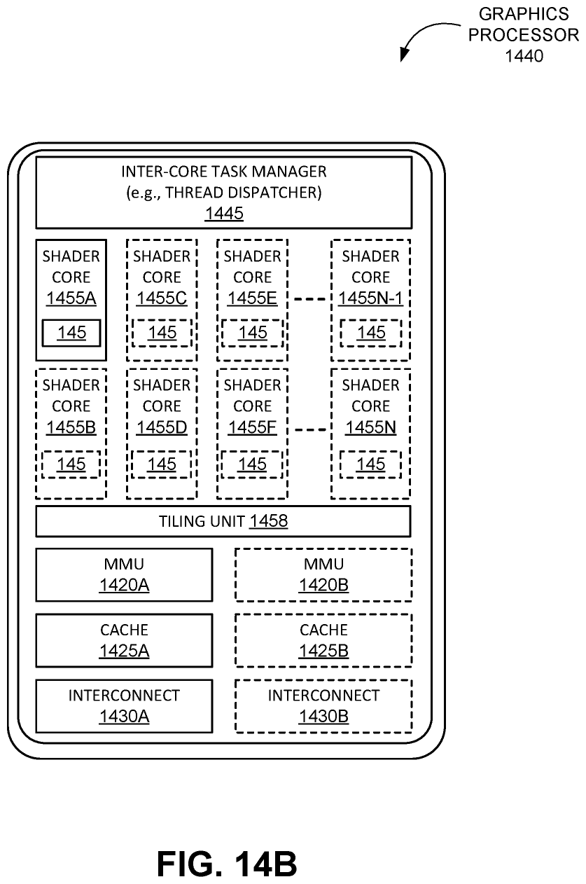

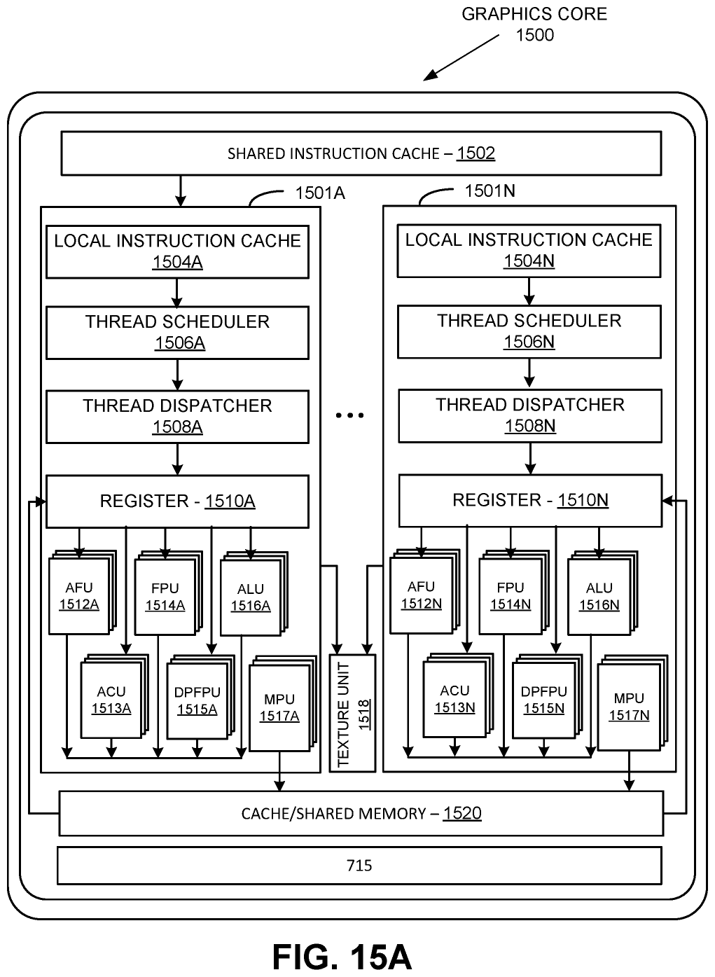

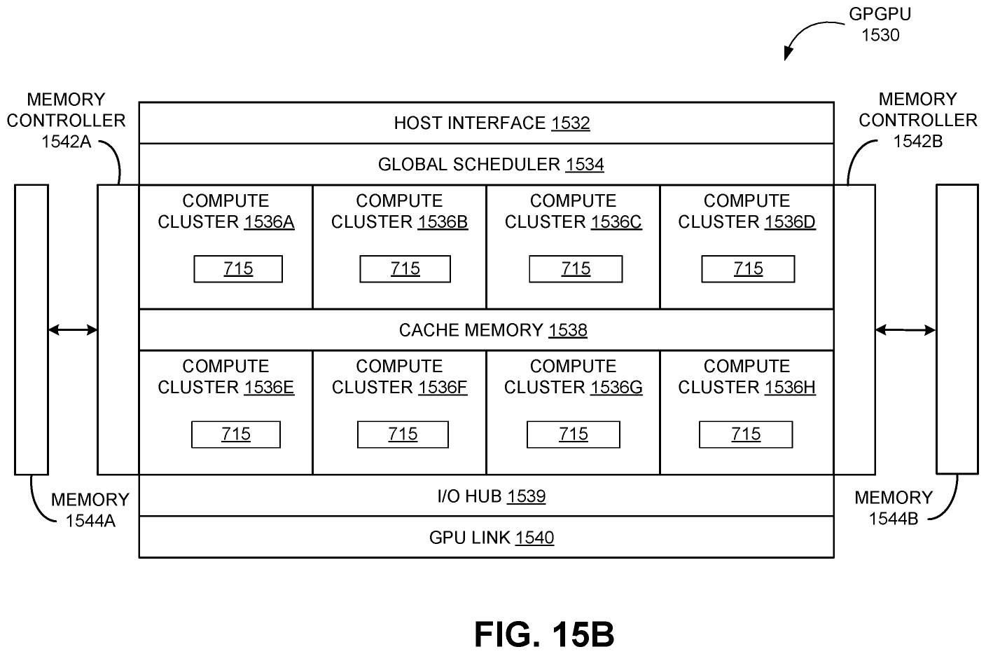

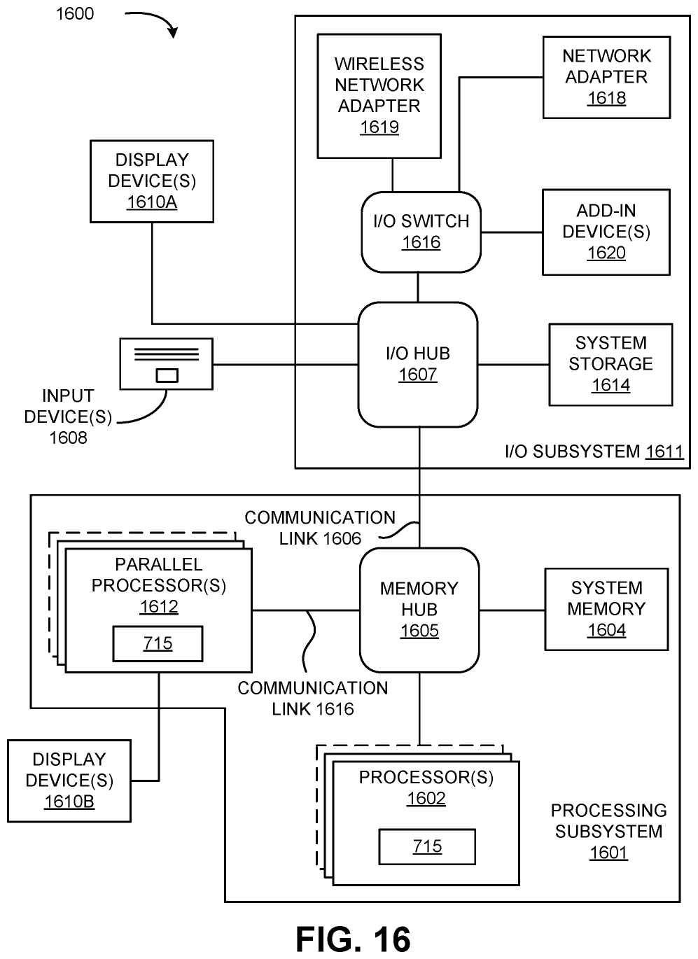

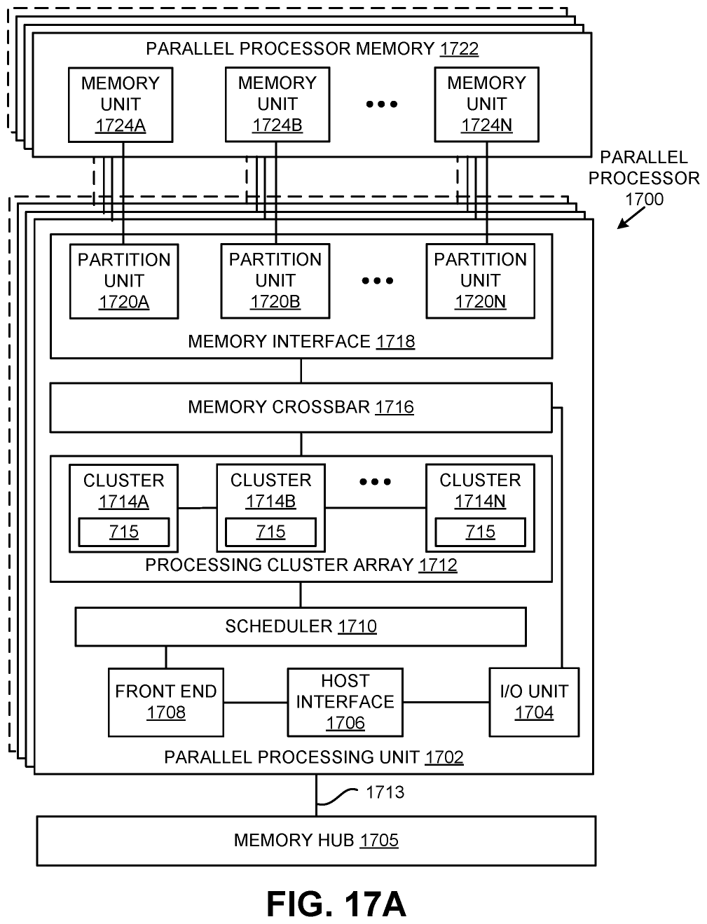

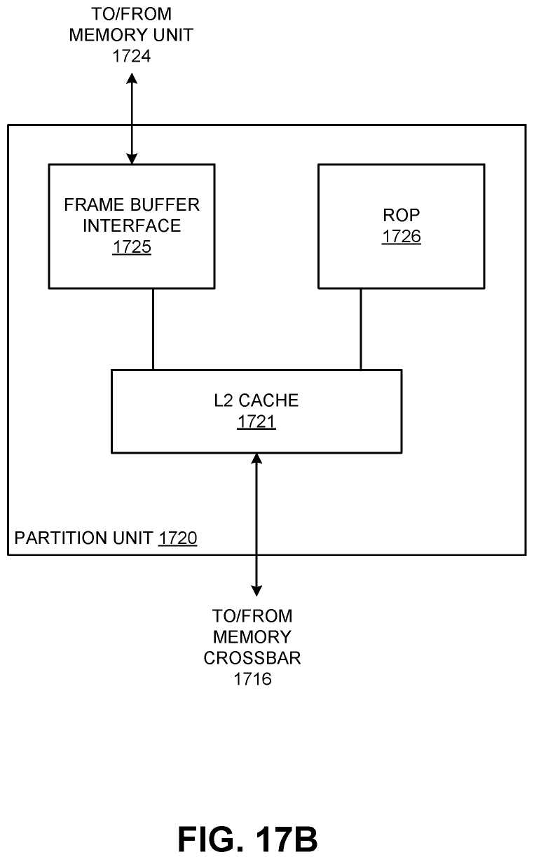

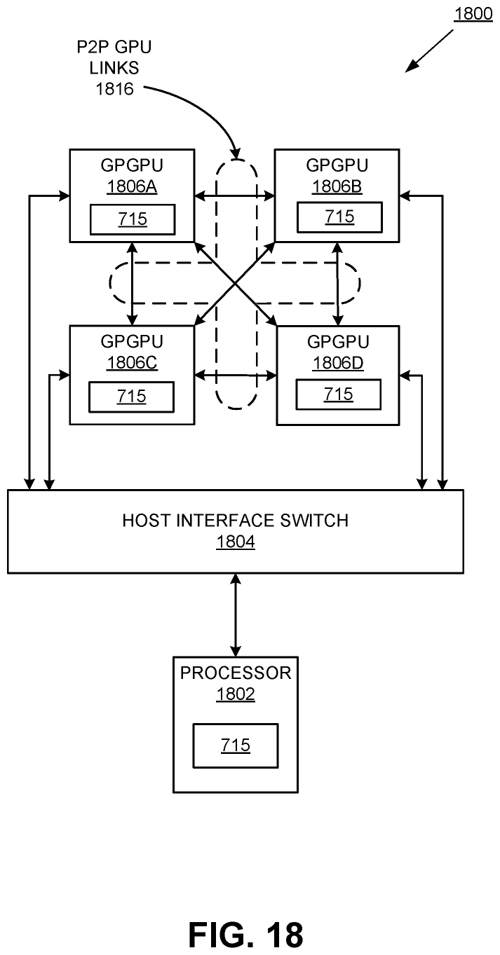

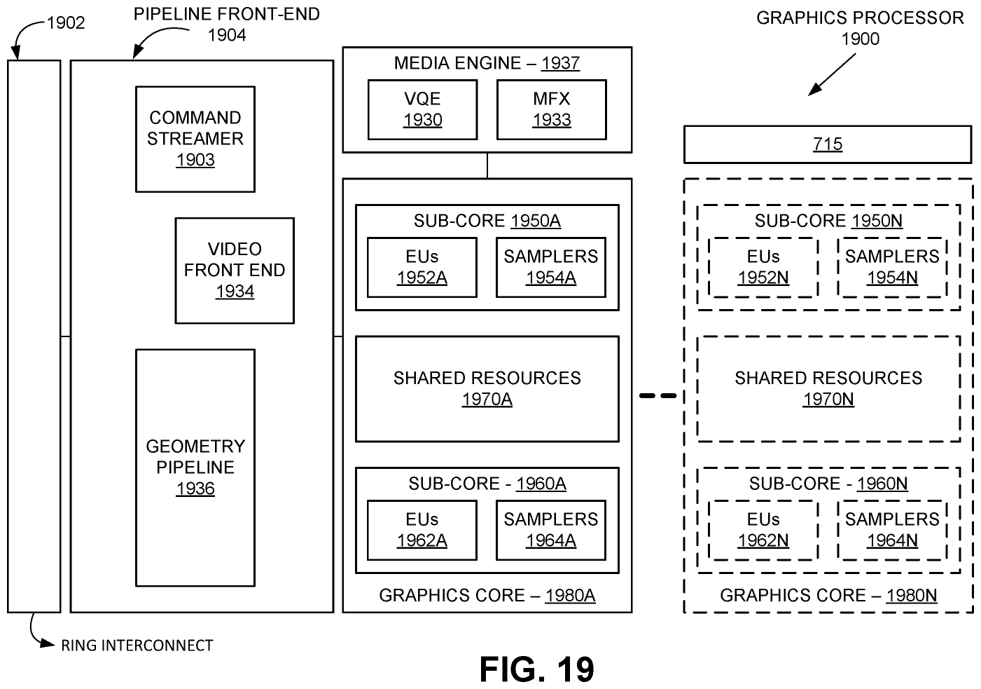

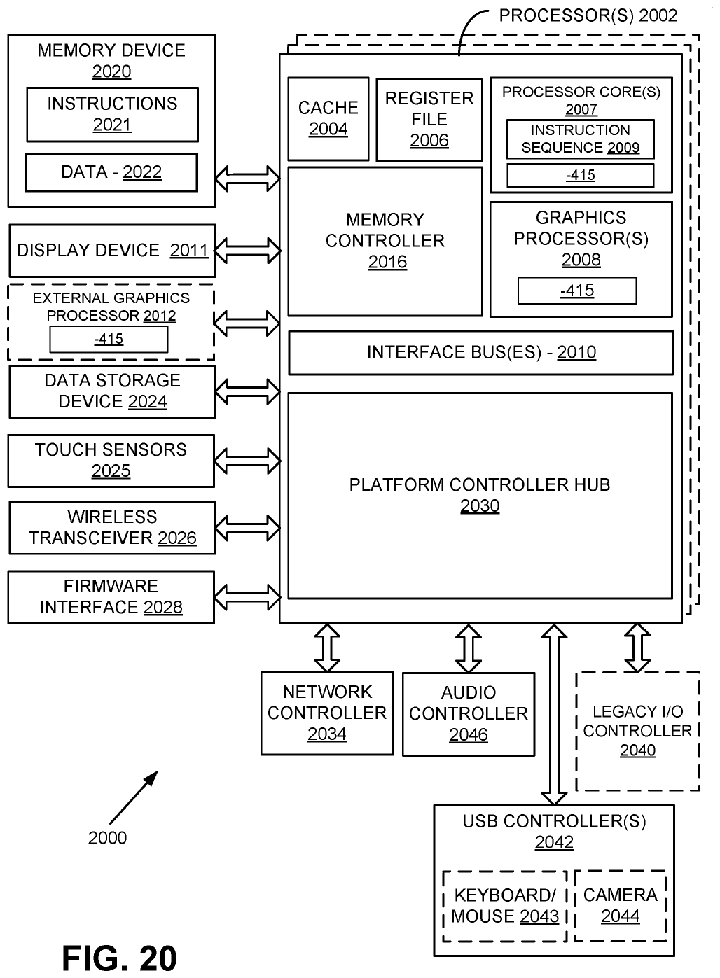

FIG. 11 is a block diagram of a processor 1100 having one or more processor cores 1102A-1102N, an integrated memory controller 1114, and an integrated graphics processor 1108, according to at least one embodiment. In at least one embodiment, processor 1100 can include additional cores up to and including additional core 1102N represented by dashed lined boxes. In at least one embodiment, each of processor cores 1102A-1102N includes one or more internal cache units 1104A-1104N. In at least one embodiment, each processor core also has access to one or more shared cached units 1106.

In at least one embodiment, internal cache units 1104A-1104N and shared cache units 1106 represent a cache memory hierarchy within processor 1100. In at least one embodiment, cache memory units 1104A-1104N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1106 and 1104A-1104N.

In at least one embodiment, processor 1100 may also include a set of one or more bus controller units 1116 and a system agent core 1110. In at least one embodiment, one or more bus controller units 1116 manage a set of peripheral buses, such as one or more PCI or PCI express busses. In at least one embodiment, system agent core 1110 provides management functionality for various processor components. In at least one embodiment, system agent core 1110 includes one or more integrated memory controllers 1114 to manage access to various external memory devices (not shown).

In at least one embodiment, one or more of processor cores 1102A-1102N include support for simultaneous multi-threading. In at least one embodiment, system agent core 1110 includes components for coordinating and operating cores 1102A-1102N during multi-threaded processing. In at least one embodiment, system agent core 1110 may additionally include a power control unit (PCU), which includes logic and components to regulate one or more power states of processor cores 1102A-1102N and graphics processor 1108.

In at least one embodiment, processor 1100 additionally includes graphics processor 1108 to execute graphics processing operations. In at least one embodiment, graphics processor 1108 couples with shared cache units 1106, and system agent core 1110, including one or more integrated memory controllers 1114. In at least one embodiment, system agent core 1110 also includes a display controller 1109 to drive graphics processor output to one or more coupled displays. In at least one embodiment, display controller 1109 may also be a separate module coupled with graphics processor 1108 via at least one interconnect, or may be integrated within graphics processor 1108.

In at least one embodiment, a ring based interconnect unit 1112 is used to couple internal components of processor 1100. In at least one embodiment, an alternative interconnect unit may be used, such as a point-to-point interconnect, a switched interconnect, or other techniques. In at least one embodiment, graphics processor 1108 couples with ring interconnect 1112 via an I/O link 1113.

In at least one embodiment, I/O link 1113 represents at least one of multiple varieties of I/O interconnects, including an on package I/O interconnect which facilitates communication between various processor components and a high-performance embedded memory module 1118, such as an eDRAM module. In at least one embodiment, each of processor cores 1102A-1102N and graphics processor 1108 use embedded memory modules 1118 as a shared Last Level Cache.

In at least one embodiment, processor cores 1102A-1102N are homogenous cores executing a common instruction set architecture. In at least one embodiment, processor cores 1102A-1102N are heterogeneous in terms of instruction set architecture (ISA), where one or more of processor cores 1102A-1102N execute a common instruction set, while one or more other cores of processor cores 1102A-1102N executes a subset of a common instruction set or a different instruction set. In at least one embodiment, processor cores 1102A-1102N are heterogeneous in terms of microarchitecture, where one or more cores having a relatively higher power consumption couple with one or more power cores having a lower power consumption. In at least one embodiment, processor 1100 can be implemented on one or more chips or as an SoC integrated circuit.

Such components can be used to reorder and process workload items in an efficient manner.

A computer-implemented method for processing workload items is provided. A plurality of workload items to be processed at least partially in parallel can be identified. Coherence information associated with the plurality of workload items can be determined. The plurality of workload items can be enqueued in a segmented queue. The plurality of workload items can be sorted based at least on a similarity of the coherence information. The sorted plurality of workload items can be stored to the queue. Using a set of processing units, the workload items in the queue can be processed, at least partially in parallel, according to an order of the sorting. In accordance with an example embodiment, the plurality of workload items can be associated with one or more ray hit points detected in scene data. The coherence information can be determined based at least on shader identifier data associated with one or more objects detected in the scene data. In at least one example, one or more coherence keys corresponding to the coherence information can be computed, key values can be assigned to the coherence key, and an ordering of the sorting can be determined based at least on the key values. In some example embodiments, compressed key bits present in a workload item can be dynamically allocated to the coherence information, prior to the sorting of the items. The coherence keys include one or more of: a shader identifier corresponding to a shader code identifying a code portion for future execution, one or more application-provided values associated with the coherence keys, an object identifier corresponding to an object located in scene data, and a primitive identifier for use in extracting data coherence. In accordance with an example embodiment, the plurality of workload items can be partitioned into one or more segments organized as a ring buffer in memory. The plurality of workload items can be sorted after a segment has been filled with unsorted items. After the workload items have been processed, the segment can be provided for use for additional workload items.

Other variations are within spirit of present disclosure. Thus, while disclosed techniques are susceptible to various modifications and alternative constructions, certain illustrated embodiments thereof are shown in drawings and have been described above in detail. However, there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. That these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method, comprising:
determining coherence information associated with a plurality of workload items to be processed at least partially in parallel;
enqueuing the plurality of workload items in a queue;
sorting the plurality of workload items in the queue based at least on a similarity of the coherence information; and
processing, using a set of processing units, the workload items in the queue at least partially in parallel according to an order of the sorting.

2. The computer-implemented method of claim 1, wherein the plurality of workload items are associated with one or more ray hit points detected in data for a scene to be rendered; and
wherein the coherence information is determined based at least on shader identifier data associated with one or more objects detected in the scene data.

3. The computer-implemented method of claim 1, wherein the coherence information includes at least one of execution coherence or data coherence.

4. The computer-implemented method of claim 1, further comprising:
computing one or more coherence keys corresponding to the coherence information; and
determining an ordering of the sorting based at least on one or more key values for the one or more coherence keys.

5. The computer-implemented method of claim 4, further comprising dynamically allocating compressed key bits present in a workload item to the coherence information, prior to the sorting of the items.

6. The computer-implemented method of claim 4, wherein the coherence keys include one or more of: a shader identifier corresponding to a shader code identifying a code portion for future execution, one or more application-provided values associated with the coherence keys, an object identifier corresponding to an object located in scene data, or a primitive identifier for use in extracting data coherence.

7. The computer-implemented method of claim 1, further comprising:
partitioning the plurality of workload items into one or more segments organized as a ring buffer in memory;
sorting the plurality of workload items after a segment has been filled with unsorted items; and
after the workload items have been processed, providing the segment for use for additional workload items.

8. A processor, comprising:
one or more processing units to:
determine coherence information associated with a plurality of parallel workload items;
sort the plurality of parallel workload items based at least on a determined similarity of the coherence information; and
process the workload items at least partially in parallel according to a sorting order of the plurality of parallel workload items.

9. The processor of claim 8, wherein the plurality of workload items are associated with one or more ray hit points detected in scene data; and
wherein the coherence information is determined based at least on shader identifier data associated with one or more objects detected in the scene data.

10. The processor of claim 8, wherein the coherence information includes at least one of execution coherence or data coherence.

11. The processor of claim 8, wherein the one or more processing units are further configured to:
compute one or more coherence keys corresponding to the coherence information; and
determine an ordering of the sorting based at least on key values for the one or more coherence keys.

12. The processor of claim 11, wherein the one or more processing units are further configured to:
dynamically allocate compressed key bits present in a workload item to the coherence information prior to the sorting of the items.

13. The processor of claim 8, wherein the one or more processing units are further configured to:
partition the plurality of workload items into one or more segments organized as a ring buffer in memory;
sort the plurality of workload items after a segment has been filled with unsorted items; and
after the workload items have been processed, provide the segment for use for additional workload items.

14. The processor of claim 8, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets; or
a system implemented at least partially using cloud computing resources.

15. A system, comprising:
one or more processors to determine coherence information associated with a plurality of parallel workload items to be processed, sort the plurality of parallel workload items based at least on a determined similarity of the coherence information, and process the workload items at least partially in parallel according to a sorting order of the plurality of parallel workload items.

16. The system of claim 15, wherein the plurality of workload items are associated with one or more ray hit points detected in scene data, and wherein the coherence information is determined based at least on shader identifier data associated with one or more objects detected in the scene data.

17. The system of claim 15, wherein the coherence information includes at least one of execution coherence or data coherence.

18. The system of claim 15, wherein the one or more processors are further to:
compute one or more coherence keys corresponding to the coherence information;
determine an ordering of the sorting based at least on the key values for the one or more coherence keys.

19. The system of claim 18, wherein the one or more processors are further to:
dynamically allocate compressed key bits present in a workload item to the coherence information, prior to the sorting of the items.

20. The system of claim 15, wherein the at least one processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets; or
a system implemented at least partially using cloud computing resources.
